(19) United States
(12) Patent Application Publication
(10) Pub. No.: US 2019/0373421 A1
(43) Pub. Date: Dec. 5, 2019

(54) Mobile Pastor Application for Smartphones and Web Browsers

(71) Applicant: John Nadasi, Plentywood, MT (US)

(72) Inventor: John Nadasi, Plentywood, MT (US)

(21) Appl. No.: 15/990,823

(22) Filed: May 29, 2018

(51) Int. Cl. H04W 4/16

(52) U.S. Cl. CPC H04W 4/16; H04W 4/02

(57) ABSTRACT

A software application for facilitating access to pastoral service comprising a software program operating on a plurality of computer devices with Internet access. The plurality of computer devices interconnected by an Internet communication protocol including a subset of the computer devices being used by clergy. A multi-tiered selection of pastoral services provided by the clergy and including an on-call service for clergy to respond on-site or by remote video/audio communication to a crisis situation 24/7 in real time. The plurality of computer devices interconnected by the Internet communication protocol facilitate contacting said clergy to provide the multi-tiered selection of pastoral services.

### CROSS-REFERENCE TO RELATED APPLICATION(S)

Not applicable.

### BACKGROUND OF THE INVENTION

### 1. Field of Invention

The present invention relates to the field of computer-assisted religious services, more particularly to matching individuals and emergency personnel to religious facilities and clergy.

### 2. Description of Related Art

Many individual traveling or going about their daily lives will have need of religious services, be it locating a place to worship while on a trip to wanting clergy during a sudden crisis (e.g., a car accident victim with critical injuries wanting last rites). Currently, finding religious services can involve fairly conventional web searches on the Internet using search services such as Bing or Google. These searches really provide poor results when seeking personalized, immediate accessible clergy and instead provide access to churches, synagogues, mosques, temples and the like, online worship services, and similar worship related activities. However, crisis services primarily related to pastoral care are not available.

When confronted with a sudden crisis (airplane crashes, car accidents, fires, etc.), especially when traveling, but also in non-urbanized areas, obtaining instantly responsive clergy for pastoral care or intervention can prove to be an impossible tasks, This can be especially problematic with religions beyond the “Big Three”—Christian, Jewish, and Islam. For example, finding an immediate Shinto or Hindu clergy 24/7 can generally be considered an impossible task even in an urban setting such as Dallas, Texas or Chicago, Illinois; both of which are common travel destination of Japanese and Indian nationals.

Based on the foregoing, there is a need in the art a communication method over computer-based networks which will facilitate locating clergy available “on-call” to provide pastoral services.

### SUMMARY OF THE INVENTION

A software application for facilitating access to pastoral service comprising a software program operating on a plurality of computer devices with Internet access. The plurality of computer devices interconnected by an Internet communication protocol including a subset of the computer devices being used by clergy. A multi-tiered selection of pastoral services provided by the clergy and including an on-call service for clergy to respond on-site or by remote video/audio communication to a crisis situation 24/7 in real time. The plurality of computer devices interconnected by the Internet communication protocol facilitate contacting said clergy to provide the multi-tiered selection of pastoral services.

The multi-tiered selection of pastoral services comprises a “Chaplain on Call” service provided to first responders facilitating contacting trained chaplains prepared to respond to high stress situations 24/7.

The multi-tiered selection of pastoral services comprises a “Panic Button” service to provide instant connection to a first available trained pastoral care provider for an emergency situation 24/7.

The pastoral services respond to a mass casualty event, a disaster event, an airliner crash, a commuter train accident, a large fire, a terrorist attack, or the like.

The multi-tiered selection of pastoral services comprises an individual matching with a religious service provided by religious facilities.

The multi-tiered selection of pastoral services comprises a GPS-enabled service.

The multi-tiered selection of pastoral services comprises at least one of providing religious service and location information, chat room services, or pairing services.

The multi-tiered selection of pastoral services comprises facilitating scheduling real time clergy or lay visits or supporting a chat service.

The multi-tiered selection of pastoral services comprises arranging and scheduling specific duties from a remote location.

The specific duties comprise bible studies, preaching, prayers, marital, and family counseling.

The multi-tiered selection of pastoral services can be used for small churches in remote locations to support clergy.

The multi-tiered selection of pastoral services can be used by nursing homes, jails, prisons, and other organizations to obtain clergy services.

Advantages:

1. Improved centralization of houses of worship on one application

2. Improved ability to connect with people with similar likes and beliefs

3. Ability to reach counseling service as needed.

4. Ability to visit online worship services.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a schematic block diagram of components of the mobile computer/communication device, according to an embodiment of the present invention; and

FIG. 2 is a diagram of the Internet-based communication system, according to an embodiment of the present invention.

### DETAILED DESCRIPTION OF PREFERRED EMBODIMENTS

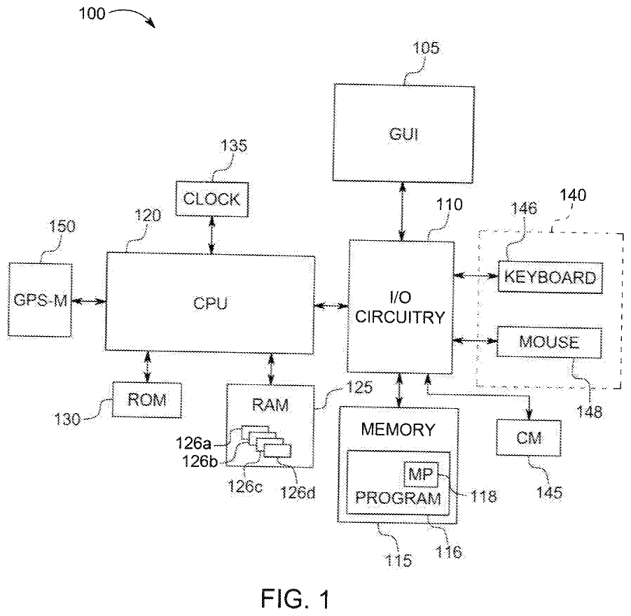

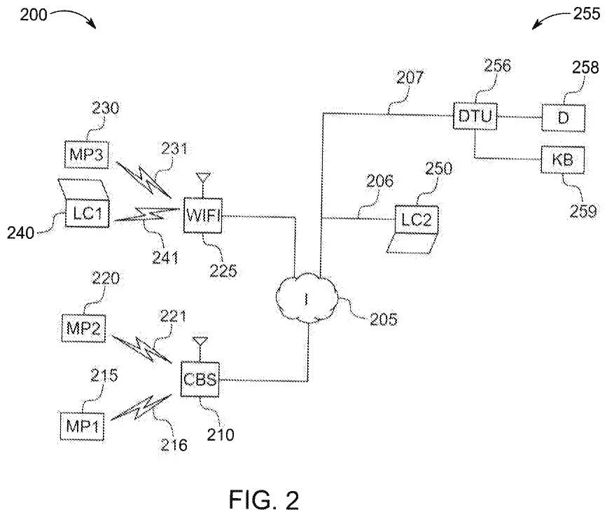

Preferred embodiments of the present invention and their advantages may be understood by referring to FIGS. 1-2, wherein like reference numerals refer to like elements.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

The computer memories in the various disclosed devices may store computer executable instructions. Each disclosed computer/communication device such as computer, a server, a system node, a smart phone, a tablet, or similar device able to execute computer code and/or process digital, electronic data may execute computer executable instructions. The computer executable instructions may be included in computer code. The computer code may be stored in the various device memories. The computer code may be written in any computer language comprising the prior art. The memory may be a non-transitory tangible storage media. Sophisticated computer apps have increasingly become available, with downloaded executable software code (e.g., the Apple® Store) providing for configuring a mobile device, such as a smart phone or tablet, to perform a plethora of functions.

The computer code may be logic encoded in one or more tangible media or one or more non-transitory tangible media for execution by the processor in the devices. Logic encoded in one or more tangible media for execution may be defined as instructions that are executable by the processor and that are provided on the computer-readable storage media, memories, or a combination thereof. Logic may include a software controlled microprocessor, an application specific integrated circuit (ASIC), an analog circuit, a digital circuit, a programmed logic device, a memory device containing instructions, and the like. The instructions may be stored on any computer readable medium comprising the prior art from which a computer, a processor, or other electronic device can read. This may include a computer data disk or the like storing computer code that can be used to configure a memory associated with a computer, a processor, or other electronic device.

The processor may include a general processor, digital signal processor, ASIC, field programmable gate array, analog circuit, digital circuit, central processing unit (CPU), micro-processor unit (MPU), micro-controller unit (MCU), combinations thereof, or other now known processor. The processor may be a single device or combinations of devices, such as associated with a network or distributed processing. The processor may be responsive to or operable to execute instructions stored as part of software, hardware, integrated circuits, firmware, micro-code or the like. The functions, acts, methods or tasks illustrated in the figures or described herein may be performed by the processor executing instructions stored in the memory.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

As depicted in FIG. 1, a schematic block diagram 100 shows the internal components of a computer smartphone, laptop, or tablet (or similar computer device) that can comprise a display 105 comprising a touch sensitive screen functioning as a graphical user interface (GUI), input/output (I/O) circuity 110 for processing and routing input and output data, memory 115 storing digital data, which can include computer programs (in the form of executable program code) 116, including the mobile pastor program/application (MP) 118 of the invention, a central processing unit (CPU) 120, with associated Random Access Memory (RAM) 125 consisting of RAM modules 126a, 126b, 127c, and 126d, Read Only Memory (ROM) 130, a clock 135 regulating the function of the tablet, and external hardwire 140 that may be attached, such as a keyboard 146 or a mouse 148, which also can serve as a GUI. However, typically touch inputs on the touch sensitive display 105, which may also include virtual graphical analogues of the mouse 148 and keyboard 146. Finally, the tablet can include a communication module (CM) 145 for accessing the Internet and transmitting or receiving data between the tablet and external data sources, such as a computer server hosting an Internet accessible website. CM 145 can support communication over a cellular mobile network or WiFi connection to interface with other devices executing MP 118.

In operation, the CPU 120 can access through I/O circuitry 110 memory 115 storing programs 116 and the fast scrolling program 118 of the invention. The CPU 120 can execute the programs 116 as well as processing any stored digital data in memory 115. The CPU 120 can also operate to process data received or transmitted via communication module 145 using I/O circuitry 110. The CPU 120 can process received data from or transmitted to communication module 145 as well as data manipulation inputs from the GUI screen 105 of the tablet or exterior hardware 140. The touch sensitive screen forming GUI 105 can receive data inputs reflecting scrolling or swiping movements of a user's finger, which the CPU 120, utilizing executed programs from memory 115, uses to process data received from communication module 145 to display that data reflecting those scrolling and swiping inputs from a user on screen 105.

CPU 120 also interfaces with Global Positioning Satellite (GPS) module (GPS-M) 150. The GPS-M 150 can be used to automatically track the position of the computer device or ascertain the location of the computer device when using the MP program/app 118.

FIG. 2 shows a communication system 200 in an embodiment of the invention. Communication system 200 can comprise the Internet 205, which can function as the primary communication infrastructure supporting both wireless and wired communication over a plurality of networks. Cellular Base Station (CBS) 210 can support communication with the Internet 205 and a plurality of mobile device (e.g., smartphones, tablets, personal data assistant (PDA), and the like) in a cellular mobile communication system. As shown, a CBS 210 can interface with mobile device (MD) 1 215 and mobile device (MD) 2 220. MD 1 215 using wireless connection 216 wireless connection 221 respectively.

Internet 205 can also be interfaced with WiFi access point 225. WiFi access point 225 can be wirelessly connected to MD 3 230 wireless connection 231 and laptop computer (LC) 1 240. Internet 205 can also communicate using wire connections. As depicted, wire connection 206 can facilitate communication with LC 2 250, and wire connection 207 can facilitate communication with desk top computer (DT) 1 255, consisting of desk top unit (DTU) 256, display (D) and key board (KB) 259.

In an embodiment, the various computer devices 215, 220, 230, 240, 250, and 255 can host and run mobile pastor program/app 118, or the program can be hosted on a web site or in a web browser program. The app 118 supports both individual clergy and seekers of services, facilitating locating and requesting various religious services including worship services and pastoral care and intervention. As implemented, a multi-tier selection of services can be offered, with clergy from a plurality of different religious denomination available 24/7 by their individual mobile/computer devices operating app 118 to respond in real time to individuals in need using their mobile/computer devices using app 118.

Tier 1 services can comprise an individual matching of individuals with religious service provided by religious facilities (e.g., churches, temples, mosque, and synagogues). This functionality can be GPS-enabled and keyed to a short questionnaire on the needs of the user. The app 118 may also forward answers to the questionnaire to religious facilities along with contact numbers if wishing to be contacted. Religious service and location information can be conveyed as well. This service can be free or supported by nominal fees and/or advertising. Free chat rooms may be provided. Individual sharing similar conditions may also be paired at this level. These service can largely be unregulated.

Tier 2 services can comprise a fee-based service for individuals. This service can facilitate chat and video functions with clergy for theological and personal questions and help, but this service primarily is not designed for crisis intervention. People with similar conditions can be matched dealing with similar physical, spiritual, and family conditions. Real time clergy or lay visit companions can be assigned and scheduled for high stress situations.

Tier 3 service can be a negotiated fee-based service assigning clergy for specific duties from a remote location. This could include bible studies, preaching, prayers, marital, and family counseling. This tier can be used for small churches in remote locations to support clergy by combining parishes. This can also be used by nursing homes, jails, prisons, and other organizations wishing to be assigned a clergy member for regular, remote worship services or services for a specific need (e.g., memorial service, funerals, banquets, etc).

Tier 4 services cam comprise a professional fee-based service. This can include “Chaplain on Call” services. This can primarily be provided to first responders, EMS, State Police, National Guard, and local police. This service facilitates contacting registered professionally trained chaplains prepared to respond to high stress situations 24/7. This can include death and dismemberment of loved ones as well as pastoral care for the caretakers involved. This service can accommodate all world religions and languages by including all religious clergy willing to participate that meet minimum board standards of care. Clergy may be registered free and may be provided MP app 118 free.

Tier 5 services can comprise “Panic Button” services. This service can be fee-based to provide instant connection to the first available trained pastoral care provider for an emergency situation, and can include voice and/or video services where available. This service can primarily be intended for mass casualty, disaster events, such as airliner crashes, commuter train accidents, large fires, terrorist attacks, and the like, and can primarily be intended to contact clergy to respond on-site or provide remote services by remote video/audio services 24/7.

Ancillary services:

NEWS and WEBCASTS: From time to time the site may post relevant news.

ALERTS: GPS enabled alerts for community emergencies and active resources available.

CONNECTIVITY: The ability to contact every major and minor world religion available and willing to participate at the touch of a button. Resources in natural disaster situations seamlessly coordinated between denominations and religions instantly.

OTHER SERVICES: Other services can be added to meet the needs of the users to increase utility.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A software application for facilitating access to pastoral service, comprising:
a software program operating on a plurality of computer devices with Internet access;
the plurality of computer devices interconnected by an Internet communication protocol including a subset of said computer devices being used by clergy;
a multi-tiered selection of pastoral services provided by said clergy, said multi-tiered selection of services including an on-call service for clergy to respond on-site or by remote video/audio communication to a crisis situation 24/7 in real time; and
wherein the plurality of computer devices interconnect by the Internet communication protocol to facilitate contacting said clergy to provide the multi-tiered selection of pastoral services.

2. The software application for facilitating access to pastoral service of claim 1, wherein the multi-tiered selection of pastoral services comprises a “Chaplain on Call” service provided to first responders facilitating contacting trained chaplains prepared to respond to high stress situations 24/7.

3. The software application for facilitating access to pastoral service of claim 1, wherein the multi-tiered selection of pastoral services comprises a “Panic Button” service to provide instant connection to a first available trained pastoral care provider for an emergency situation 24/7.

4. The software application for facilitating access to pastoral service of claim 3, wherein the pastoral services respond to a mass casualty event, a disaster event, an airliner crash, a commuter train accident, a large fire, a terrorist attack, or the like.

5. The software application for facilitating access to pastoral service of claim 1, wherein the multi-tiered selection of pastoral services comprises an individual matching with a religious service provided by religious facilities.

6. The software application for facilitating access to pastoral service of claim 1, wherein the multi-tiered selection of pastoral services comprises a GPS-enabled service.

7. The software application for facilitating access to pastoral service of claim 1, wherein the multi-tiered selection of pastoral services comprises at least one of providing religious service and location information, chat room services, or pairing services.

8. The software application for facilitating access to pastoral service of claim 1, wherein the multi-tiered selection of pastoral services comprises facilitating scheduling real time clergy or lay visits or supporting a chat service.

9. The software application for facilitating access to pastoral service of claim 1, wherein the multi-tiered selection of pastoral services comprises arranging and scheduling specific duties from a remote location.

10. The software application for facilitating access to pastoral service of claim 9, wherein the specific duties comprises bible studies, preaching, prayers, marital, and family counseling.

11. The software application for facilitating access to pastoral service of claim 1, wherein the multi-tiered selection of pastoral services can be used for small churches in remote locations to support clergy.

12. The software application for facilitating access to pastoral service of claim 1, wherein the multi-tiered selection of pastoral services can be used by nursing homes, jails, prisons, and other organizations to obtain clergy services.
